(19) United States
(12) Patent Application Publication
(10) Pub. No.: US 2024/0283355 A1
(43) Pub. Date: Aug. 22, 2024

(54) POWER CONVERSION DEVICE AND POWER CONVERSION CIRCUIT

(71) Applicant: SHANGHAI METAPWR ELECTRONICS CO., LTD, Shanghai (CN)

(72) Inventor: Jianhong ZENG, Shanghai (CN)

(73) Assignee: SHANGHAI METAPWR ELECTRONICS CO., LTD, Shanghai (CN)

(21) Appl. No.: 18/434,771

(22) Filed: Feb. 6, 2024

(30) Foreign Application Priority Data
Feb. 19, 2023 (CN) 202310137509.X

(51) Int. Cl. H02M 3/00; H01F 27/24; H01F 27/28; H02M 1/00

(52) U.S. Cl. CPC H02M 3/003; H01F 27/24; H01F 27/2804; H02M 1/0064

(57) ABSTRACT

A power conversion device and a power conversion circuit are provided. The power conversion device comprises a first winding, a second winding and a third winding, wherein the first end part and the second end part of the third winding are provided with projection overlapping regions, and the first end part of the first winding and the first end part of the second winding do not have a projection overlapping region. A layout of the power conversion device is provided, which comprises a magnetic component region, a switch region, an output capacitor region and a component. The power conversion circuit comprises a pre-charging circuit and a connecting switch, and the pre-charging circuit comprises two switching tubes, a pre-charging inductor and at least one pre-charging capacitor.

### CROSS-REFERENCE TO RELATED APPLICATION

This application claims the priority benefit of China application serial no. 202310137509.X filed on Feb. 19, 2023. The entirety of the above-mentioned patent application is hereby incorporated by reference herein and made a part of this specification.

### BACKGROUND

### Technical Field

The invention relates to a high-frequency power supply, in particular to a power conversion device and a power conversion circuit.

### Description of Related Art

Along with the development of artificial intelligence, the power requirements of an artificial intelligence data processing chip, such as a CPU, a GPU, TPU and the like (collectively referred to as XPU) are higher and higher, so that the power of the server is greatly increased, the power supply voltage of the server system board rises from 12V to 48V, and the two-stage voltage reduction circuit architecture gradually becomes mainstream when the power supply voltage of the server system board is 48V.

The intermediate bus conversion device in the two-stage voltage reduction circuit architecture is a conversion device for realizing voltage conversion between an input bus and an output bus, and the ratio of the input voltage to the output voltage is of a fixed gain ratio or an unfixed gain ratio. The ratio of the fixed gain ratio to the output voltage is 4:1, 8:1 and the like.

The intermediate bus conversion device with the fixed gain ratio usually adopts an LLC circuit topological structure, and the circuit topology can realize zero-voltage turn-on or zero-current turn-off of the switch connected with the transformer at the same time, and has the characteristics of high switch switching frequency, high power conversion efficiency, high power density and the like. On a server mainboard with a large area, due to the fact that the power is large and the transmission distance is long, the number of power supply channels required by the artificial intelligence data processing chip is large, and the fixed gain ratio of the intermediate bus converter with the fixed gain ratio of 4:1 is a preferred scheme. The efficiency and power density of the 4:1 intermediate bus converter are continuously improved to be an urgent problem to be solved.

### SUMMARY

In general, one aspect features a device comprising: a magnetic component;
wherein the magnetic component comprises a magnetically permeable core and three windings, the magnetically permeable core comprises two core plates and at least two magnetic legs, the at least two magnetic legs are arranged between the two core plates, and a channel between every two adjacent magnetic legs is a winding channel;
wherein the magnetically permeable core further comprises a first port of the channel and a second port of the channel which are opposite to each other, the first port of the channel and the second port of the channel are two side faces of two core plates, and the winding channel penetrates through the first port of the channel and the second port of the channel;
wherein the three windings penetrate through the winding channel respectively, each winding in the three windings comprises a first end and a second end, and the first end and the second end of each winding in the three windings are arranged on the same side of the magnetically permeable core;
wherein the three windings are respectively a first winding, a second winding and a third winding, and the second end of the first winding and the second end of the second winding have different polarities and are electrically connected;
wherein the third winding comprises a first end part and a second end part, the first end part and the second end part are horizontally crossed, and a projection overlapping area is formed.

Implementations of the device may include one or more of following features. Further comprising a winding substrate, the three windings being arranged in the winding substrate, the winding substrate comprising at least two magnetically-permeable-core holes, and the magnetically-permeable-core holes allowing the magnetic legs to pass through.

Implementations of the device may include one or more of following features. The first winding and the second winding respectively comprise a first end part, and the first end part of the first winding and the first end part of the second winding are not horizontally crossed to form a projection overlapping area.

Implementations of the device may include one or more of following features. The number of the at least two magnetic legs is three, the three magnetic legs are respectively a first side leg, a middle leg and a second side leg, the first side leg, the middle leg and the second side leg are arranged in the same direction, and a channel between every two adjacent magnetic legs is a winding channel;
wherein each winding sequentially passes through the two winding channels and is wound around the middle leg for at least one circle.

Implementations of the device may include one or more of following features. A first end and a second end of each of the three windings are disposed on a first port of the channel of the magnetically permeable core.

Implementations of the device may include one or more of following features. Further comprising a first switch bridge arm and a second switch bridge arm, wherein each switch bridge arm comprises an upper switch, a middle switch and a lower switch, the upper switch, the middle switch and the lower switch are sequentially and electrically connected in series, the connection points of the upper switch and the middle switch are upper nodes, and the connection points of the middle switch and the lower switch are lower nodes.

Implementations of the device may include one or more of following features. The first end of the first winding and the first end of the second winding are electrically connected with the lower nodes of the first switch bridge arm and the second switch bridge arm respectively.

Implementations of the device further comprising a resonant capacitor, wherein after the first end part and the second end part of the third winding are horizontally crossed, the first end of the third winding is electrically connected with the upper node of the first switch bridge arm, the second end of the third winding is electrically connected with one end of the resonant capacitor, and the other end of the resonant capacitor is electrically connected with the upper node of the second switch bridge arm.

Implementations of the device may include one or more of following features. The winding substrate comprises a first surface and a second surface opposite to each other, the first surface comprises a first bridge arm area and a second bridge arm area, and the second surface comprises a first bridge arm area and a second bridge arm area; at least one part of the switch of the first switch bridge arm is arranged in the first bridge arm area, and all or part of the switches of the second switch bridge arm are arranged in the second bridge arm area.

Implementations of the device may include one or more of following features. The at least one part of the switch is a lower switch and a middle switch of the same switch bridge arm.

Implementations of the device may include one or more of following features. A straight line parallel to the winding substrate and passing through the first port of the channel, the second port of the channel and the middle leg at the same time, and the first bridge arm region and the second bridge arm region are respectively located on two sides of the straight line.

Implementations of the device may include one or more of following features. There is a straight line passing through the magnetically permeable core and parallel to the winding substrate, and the first bridge arm region and the second bridge arm region are respectively located on two sides of the straight line.

Implementations of the device may include one or more of following features. The straight line is perpendicular to the winding channel.

Implementations of the device may include one or more of following features. There is a straight line passing through the projection overlapping region and parallel to the winding substrate, and the node of the first bridge arm and the node of the second bridge arm are respectively located on two sides of the straight line.

In general, one aspect features a device comprising: a first voltage terminal, a second voltage terminal, two switch bridge arms, a magnetic component and a pre-charging circuit;

wherein the first voltage terminal comprises a first voltage positive terminal and a first voltage negative terminal, the second voltage terminal comprises a second voltage positive terminal and a second voltage negative terminal, and the first voltage negative terminal is short-circuited with the second voltage negative terminal;
wherein the two switch bridge arms are connected in parallel between a first voltage positive terminal and a first voltage negative terminal, each switch bridge arm comprises an upper switch, a middle switch and a lower switch, the upper switch, the middle switch and the lower switch are sequentially and electrically connected in series, the connecting points of the upper switch and the middle switch are upper nodes, and the connecting points of the middle switch and the lower switch are lower nodes;
wherein the magnetic component comprises a first winding and a second winding, the first winding and the second winding respectively comprise a first end and a second end, the second end of the first winding is electrically connected with the second end of the second winding and is electrically connected with the positive terminal of the second voltage, and the first ends of the first winding and the second winding are electrically connected with the lower node respectively;
wherein before the middle switch is switched on, the pre-charging circuit precharges the voltage of the second voltage terminal to a pre-determined voltage, so that the rated voltage value of each upper switch is less than 1.1 times of the maximum steady-state voltage of the first voltage terminal.

Implementations of the device may include one or more of following features. The rated voltage value of each of the upper switches is less than 0.9 times of the maximum steady-state voltage of the first voltage terminal.

Implementations of the device may include one or more of following features. The rated voltage value of each of the upper switches is less than 0.7 times of the maximum steady-state voltage of the first voltage terminal.

Implementations of the device may include one or more of following features. The pre-charging circuit is bridged between the first voltage terminal and the second voltage terminal.

Implementations of the device may include one or more of following features. The first voltage terminal is an input terminal, and the second terminal voltage is an output terminal;

wherein the pre-determined voltage is greater than 70% of the steady-state voltage of the second voltage terminal.

Implementations of the device may include one or more of following features. The pre-charging circuit comprises a switch terminal, an inductor end and a grounding terminal, the switch terminal is electrically connected with the first voltage positive terminal, the inductor end is electrically connected with the second voltage positive terminal, and the grounding terminal is electrically connected with the first voltage negative terminal and the second voltage negative terminal.

Implementations of the device may include one or more of following features. The pre-charging circuit further comprises two switches, a pre-charging inductor and a pre-charging capacitor, the two switches are electrically connected in series and bridged between the switch terminal and the grounding terminal, the pre-charging inductor is bridged between the series connection point and the inductance terminal of the two switches, and the pre-charging capacitor is bridged between the inductance terminal and the grounding terminal.

Implementations of the device may include one or more of following features. Further comprising a connection switch, wherein the connection switch is electrically connected between the inductance terminal of the pre-charging circuit and the second voltage positive terminal.

In general, one aspect features a circuit, comprising:
a first voltage terminal, a second voltage terminal, a pre-charging circuit and at least one connection switch;
wherein the circuit realizes mutual conversion between a first voltage terminal voltage and a second voltage terminal voltage;
wherein the pre-charging circuit comprises a pre-charging input terminal, a pre-charging output terminal and a grounding terminal;
wherein one end of the at least one connecting switch is electrically connected with the pre-charging output terminal, and the other end of the at least one connecting switch is electrically connected with the first voltage terminal or the second voltage terminal of the device;
wherein the pre-charging circuit pre-charges a first voltage terminal or a second voltage terminal of the device to a pre-determined voltage, and then the circuit starts to work;
wherein the connection switch is turned on when the pre-charging circuit charges the device and has a current flowing through the connection switch.

Implementations of the circuit may include one or more of following features. The pre-charging circuit pre-charges a first voltage terminal or a second voltage terminal of the circuit to a pre-determined voltage, and the pre-charging circuit stops working;
wherein the pre-determined voltage is greater than 70% of the output steady-state voltage of the circuit.

Implementations of the circuit may include one or more of following features. The connection switch is turned off when the output current of the pre-charging circuit is zero or a negative current;
wherein the connection switch is a diode or a controllable switch.

Implementations of the circuit may include one or more of following features. A first voltage terminal of the device is an input terminal, a second voltage terminal is an output terminal, the pre-charging input terminal is electrically connected to a first voltage terminal, and the connection switch is bridged between the pre-charging output terminal and the second voltage terminal.

Implementations of the circuit may include one or more of following features. The pre-charging circuit further comprises two switches, a pre-charging inductor and at least one pre-charging capacitor; the two switches are electrically connected in series and are bridged between the pre-charging input terminal and the grounding terminal, the pre-charging inductor is bridged between the series connection point of the two switches and the pre-charging output terminal, and the pre-charging capacitor is bridged between the pre-charging output terminal and the grounding terminal.

Implementations of the circuit may include one or more of following features. A first voltage terminal of the circuit is an output terminal, a second voltage terminal is an input terminal, the pre-charging input terminal is electrically connected with a second voltage terminal, and the connecting switch is connected between the pre-charging output terminal and the first voltage terminal in a bridging mode.

Implementations of the circuit may include one or more of following features. The pre-charging circuit further comprises two switches, a pre-charging inductor and at least one pre-charging capacitor; the two switches are electrically connected in series and are bridged between the pre-charging output terminal and the grounding terminal, the pre-charging inductor is bridged between the series connection point of the two switches and the pre-charging input terminal, and the pre-charging capacitor is bridged between the pre-charging output terminal and the grounding terminal.

Implementations of the circuit may include one or more of following features. The number of the connection switches is two, the pre-charging circuit further comprises two switches, a pre-charging inductor and two pre-charging capacitors, the two switches are electrically connected in series to form a series branch, and the electric connection point of the two switches is midpoint in the series branch; one end of the series branch is electrically connected with one end of one connection switch, and the other end of the series branch is electrically connected with the grounding terminal; and the other end of one connection switch is electrically connected with the positive terminal of the first voltage of the circuit; one end of the pre-charging inductor is electrically connected with the midpoint of the series branch, the other end of the pre-charging inductor is electrically connected with one end of the other connecting switch, and the other end of the other connecting switch is electrically connected with the positive terminal of the second voltage of the circuit; and each pre-charging capacitor is connected between one end of one connecting switch and the grounding terminal in a bridging mode.

Implementations of the circuit may include one or more of following features. At least two circuits are electrically connected in parallel, first voltage terminals of the at least two circuits are connected in parallel, and second voltage terminals of the at least two circuits are connected in parallel.

The details of one or more embodiments of the application are set forth in the accompanying drawings and description below. Other features, objects, and advantages of the application will be apparent from the description and drawings, and from the claims.

### BRIEF DESCRIPTION OF THE DRAWINGS

FIG. 1A to FIG. 2F are schematic diagrams of Embodiment 1.

FIG. 3A to FIG. 3C are schematic diagrams of Embodiment 2.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

### Embodiment 1

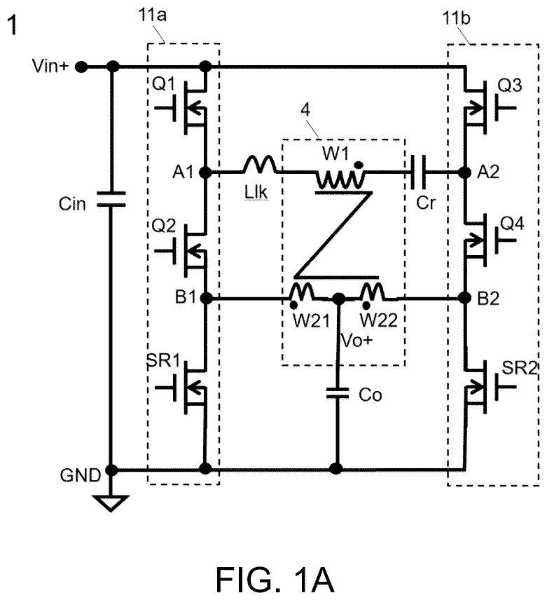

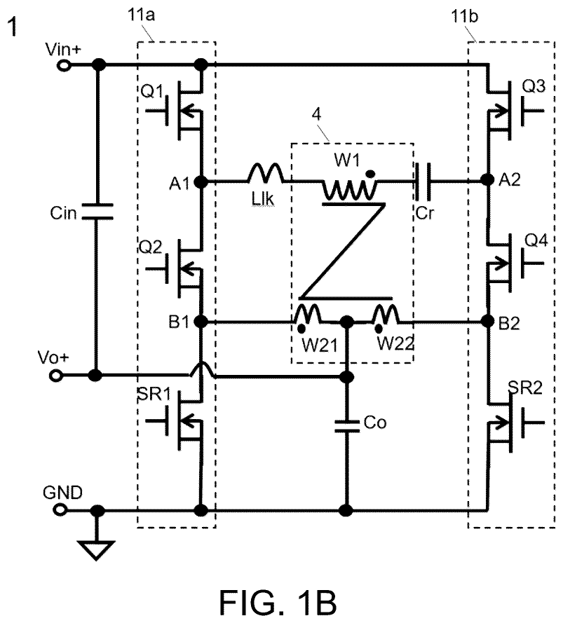

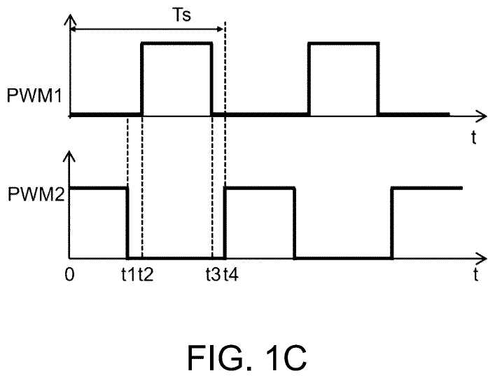

The circuit topology schematic diagram disclosed by the invention is shown in FIGS. 1A and 1B, and the circuit topology diagram shown in FIGS. 1A comprises a first voltage terminal and a second voltage terminal. In some embodiments, the first voltage terminal is an input terminal and comprises an input positive terminal Vin+and an input negative terminal Vin−; the second voltage terminal is an output terminal and comprises an output positive terminal Vo+ and an output negative terminal Vo−; in some embodiments, the input negative terminal Vin− and the output negative terminal Vo− are electrically connected into a grounding terminal GND; and the circuit topological schematic diagram shown in FIG. 1A further comprises two three-switch bridge arms, a magnetic component 4, a resonant capacitor Cr, an equivalent resonant inductance Llk, at least one input capacitor Cin and at least one output capacitor Co. The two ends of each three-switch bridge arm are electrically connected in parallel, one end of each three-switch bridge arm is electrically connected to the input positive terminal Vin+, the other end of each three-switch bridge arm is electrically connected to the grounding terminal GND, and the two ends of the input capacitor Cin are connected between the input positive terminal Vin+ and the grounding terminal GND in a bridging mode; and each three-switch bridge arm comprises three switches which are electrically connected in series. The two three-switch bridge arms are respectively a first switch bridge arm 11a and a second switch bridge arm 11b, wherein the first switch bridge arm 11a comprises an upper switch Q1, a middle switch Q2 and a lower switch SR1, the upper switch Q1 and the middle switch Q2 are electrically connected to the upper node A1, and the middle switch Q2 and the lower switch SR1 are electrically connected to the lower node B1; the second switch bridge arm 11b comprises an upper switch Q3, a middle switch Q4 and a lower switch SR2, the upper switch Q3 and the middle switch Q4 are electrically connected to the upper node A2, and the middle switch Q4 and the lower switch SR2 are electrically connected to the lower node B2. The magnetic component 4 comprises a high-voltage winding W1 (equivalent to a third winding), a low-voltage winding W21 (equivalent to a first winding) and a low-voltage winding W22 (equivalent to a second winding), wherein the high-voltage winding W1, the resonant capacitor Cr and the equivalent resonant inductance Llk are connected in series to form a series resonance branch, and the series resonance branch is bridged between the upper node A1 and the upper node A2; the first end of the high-voltage winding W1 is in short circuit with the equivalent resonant inductance LlK, and the second end of the high-voltage winding W1 is in short circuit with the resonant capacitor Cr. The second end of the low-voltage winding W21 and the second end of the low-voltage winding W22 are electrically connected to the output positive terminal Vo+, the first end of the low-voltage winding W21 is electrically connected to the lower node B1, and the first end of the low-voltage winding W22 is electrically connected to the lower node B2. The first end of the low-voltage winding W21 and the second end of the low-voltage winding W22 and the second end of the high-voltage winding are dotted terminals (i.e., the polarities are the same), and are marked as point terminals. The second end of the low-voltage winding W21 and the first end of the low-voltage winding W22 and the first end of the high-voltage winding are dotted terminals (ie, the polarities are the same), and are marked as non-point terminals. At least one output capacitor Co is bridged between the output positive terminal Vo+ and the grounding terminal GND; and the equivalent resonant inductance Llk can be the parasitic leakage inductance of the magnetic component and can be an external inductor or a combination of parasitic leakage inductance of an external inductor and a magnetic component.

The circuit topology diagram shown in FIG. 1B differs from FIG. 1A in that one end of at least one input capacitor Cin is electrically connected with the input positive terminal Vin+ and the other end is electrically connected with the output positive terminal Vot, so that one part of output current ripples generated by the two low-voltage windings flows into the output capacitor Co, the other part of the output current ripples flows into the input capacitor Cin, and two three-switch bridge arms are supplied through the input capacitor Cin, so that the ripple current flowing into the output capacitor Co can be reduced, the capacitance value of the output capacitor Co or the number of output capacitors Co can be reduced, and the purpose of further reducing the size of the power module is achieved.

The turn-on and turn-off of the switch shown in FIGS. 1A and 1B can be controlled by the pulse width modulation signal shown in FIG. 1C, wherein the first pulse width modulation signal PWM1 is used for controlling the on and off of the upper switch Q1, the middle switch Q4 and the lower switch SR1, and the second pulse width modulation signal PWM2 is used for controlling the on and off of the upper switch Q3, the middle switch Q2 and the lower switch SR2. In detail, as shown in FIG. 1C, the moment t0 to the moment t4 is a switching period, the time t1 to the moment t2 and the moment t3 to the moment t4 are dead time, and if the dead time is ignored, the duty ratio of the first pulse width modulation signal PWM1 to the second pulse width modulation signal PWM2 is 50%; and the first pulse width modulation signal PWM1 and the second pulse width modulation signal PWM2 are staggered by 180 degrees

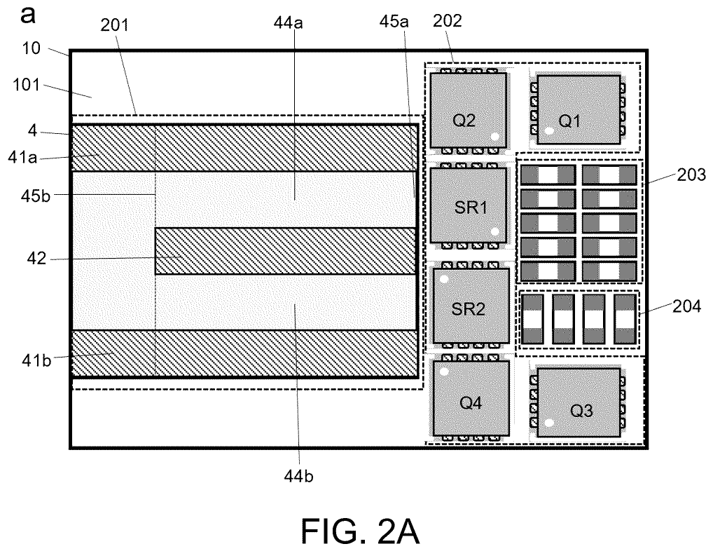

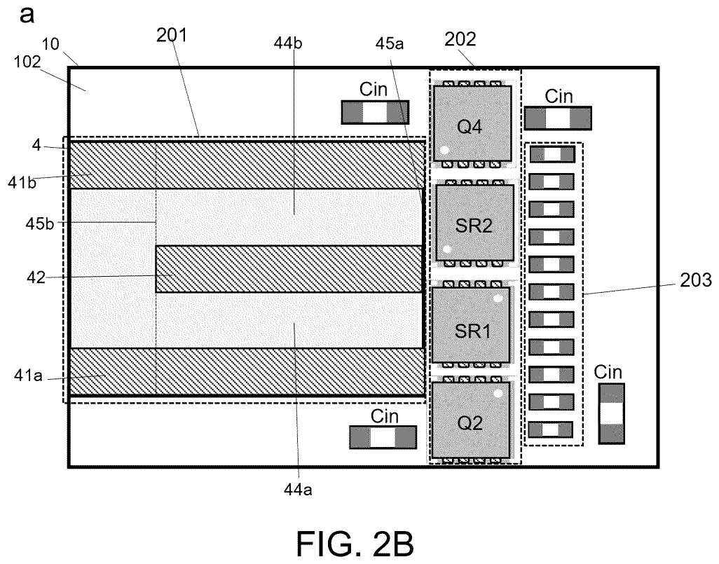

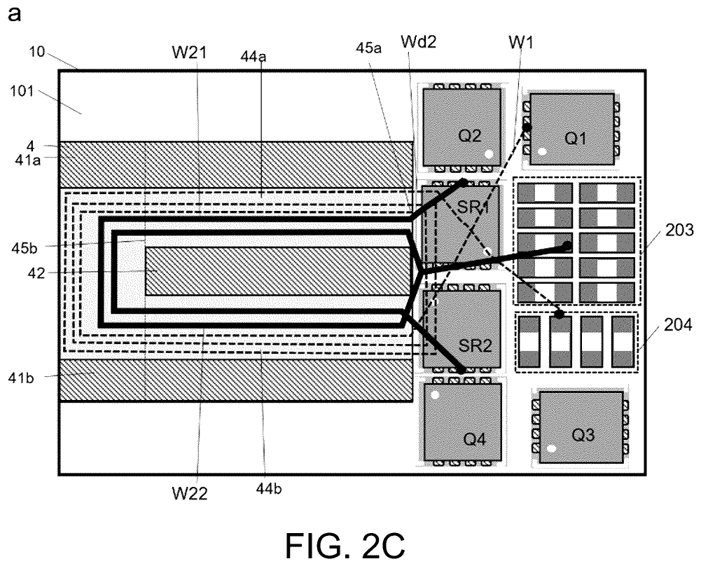

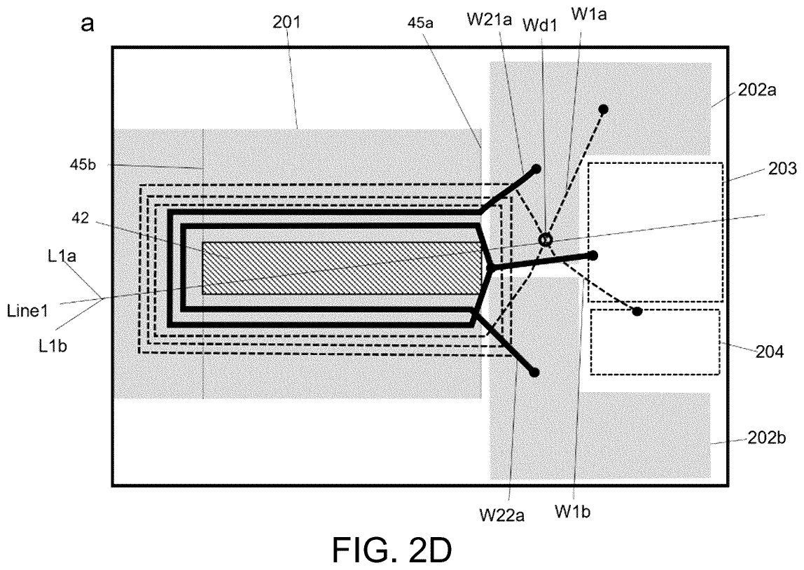

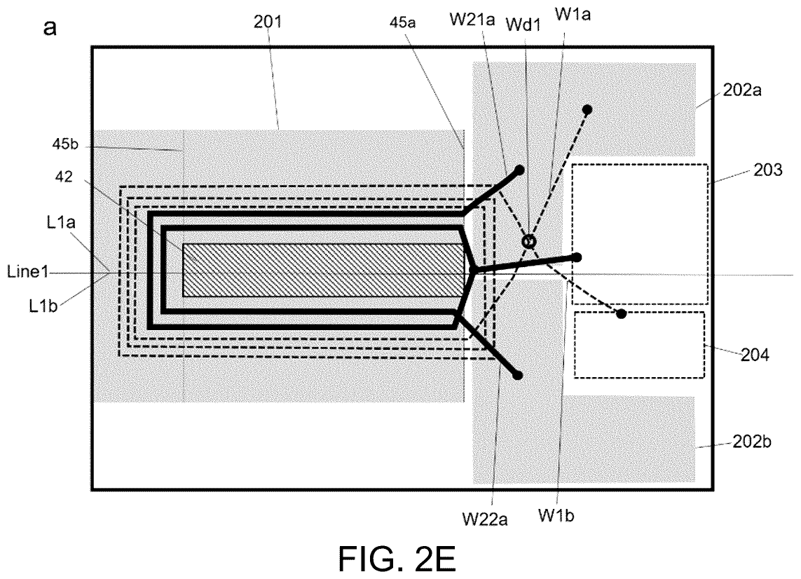

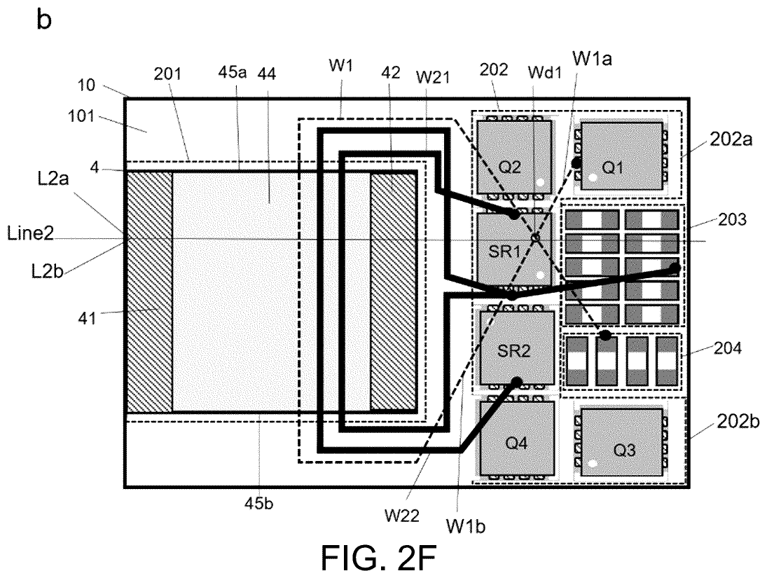

The layout of the power module A applying the circuit topology shown in FIGS. 1A and 1B and the winding method of the winding can be shown in FIGS. 2A to 2D, wherein FIG. 2A is a schematic diagram of a top surface of a power module A containing a local profile, FIG. 2B is a schematic diagram of a bottom surface of the power module A containing a partial section, and FIG. 2C is a schematic diagram of a winding method of the superposition winding on the schematic diagram of the top surface. The power module A comprises a winding substrate 10, a magnetic component 4, a plurality of switches, at least one output capacitor Co, at least one input capacitor Cin and at least one resonant capacitor Cr. In some embodiments, the equivalent resonant inductance LLK is the parasitic leakage inductance of the magnetic component 4. The winding substrate 10 comprises a first surface 101 and a second surface 102 opposite to each other, and the first surface 101 comprises a magnetic component region 201, a switch region 202, an output capacitor region 203, and a resonant capacitor region 204; the magnetic component 4 includes a magnetically permeable core 42, a high-voltage winding W1 and two low-voltage windings (equivalent to a low-voltage winding W21 and a low-voltage winding W22), wherein the magnetically permeable core 41 comprises two core plates, a first side leg 41a, a second side leg 41b and a middle leg 42 (in FIG. 2A, the upper core plate is not shown; in FIG. 2B, the lower core plate is not shown), the middle leg 42 is arranged between the first side leg 41a and the second side leg 41b, and the first side leg 41a, the second side leg 41b and the middle leg 42 are arranged between the two core plates; the three magnetic legs can be independently formed with the two core plates and can also be integrally formed with one of the core plates, or the three magnetic legs are divided into two parts, and each part is integrally formed with one core plate; A channel between the winding leg 42 and the adjacent side leg is a winding channel 44a or a winding channel 44b, one side of the winding channel is defined as a first port of the channel 45a, and the other side is defined as a second port of the channel 45b, that is, the two winding channels 44a and the winding channel 44b both pass through the first port of the channel 45a and the second port of the channel 45b; the winding substrate 10 includes three magnetically-permeable-core holes, the shape and the position of the three magnetically-permeable-core holes are corresponding with the first side leg 41a, the middle leg 42 and the second side leg 41b; the three magnetically-permeable-core holes are respectively used for the three magnetic legs to pass through; the two core plates are respectively arranged adjacent to the first surface 101 and the second surface 102; the two core plates are buckled together with the three magnetic legs passing through the magnetically-permeable-core hole to form a combination body; and the combination body is coupled with the winding arranged in the winding substrate.

The upper switch Q1, the upper switch Q3, the middle switch Q2, the middle switch Q4, the lower switch SR1 and the lower switch SR2 are arranged in the switch region 202, the middle switch Q2, the middle switch Q4, the lower switch SR1 and the lower switch SR2 are arranged along the first port of the channel 45a; the source of the lower switch SR1 and the source of the lower switch SR2 are opposite and adjacent to each other, the source of the middle switch Q2 and the drain of the lower switch SR1 are opposite and adjacent to each other, and the source of the middle switch Q4 and the drain of the lower switch SR2 are opposite and adjacent to each other; the upper switch Q1 is arranged adjacent to the middle switch Q2, and the source of the upper switch Q1 is further arranged adjacent to the middle switch Q2; and the upper switch Q3 is arranged adjacent to the middle switch Q4, and further the source of the upper switch Q3 is arranged adjacent to the middle switch Q4. In some embodiments, the middle switch Q2 is arranged between the first port of the channel 45a and the upper switch Q1, and the middle switch Q4 is arranged between the first port of the channel 45a and the upper switch Q3, but is not limited according to the limitation, and can be arranged according to actual design requirements.

At least one output capacitor Co is arranged in the output capacitor region 203, and the output capacitor region 203 is arranged adjacent to the lower switch SR1 or the lower switch SR2. In some embodiments, the lower switch SR1 and the lower switch SR2 are arranged between the first port of the channel 45a and the output capacitor region 203; the resonant capacitor region 204 is used for setting at least one resonant capacitor Cr, and the resonant capacitor region can be arranged adjacent to the region of the middle switch Q4 and the upper switch Q3. As shown in FIG. 2A, the switch Q2 and the upper switch Q1 can also be arranged adjacent to each other. In the technical features disclosed by the embodiment, the magnetic component region, the switch region and the output capacitor area are sequentially arranged in the same direction, and furthermore, the magnetic component, the at least one lower switch and the at least one output capacitor are sequentially arranged in the same direction.

As shown in FIG. 2B, the switch region 202 of the second surface 102 is provided with a middle switch Q2, a middle switch Q4, a lower switch SR1 and a lower switch SR2. In some embodiments, the two middle switches and the two lower switches are sequentially arranged along the first port of the channel 45a according to the sequence of the middle switch, the lower switch, the lower switch and the middle switch; in some embodiments, the two lower switches SR1 and the lower switch SR2 are arranged adjacent to the first port of the channel 45a, the middle switch Q2 is arranged adjacent to the lower switch SR1, and the middle switch Q4 is arranged adjacent to the lower switch SR2, that is, the two middle switches are respectively arranged adjacent to the lower switches in the same bridge arm; at least one input capacitor Cin is arranged adjacent to the upper switch Q1 and part of the output capacitor region 203, at least another input capacitor Cin is arranged adjacent to the upper switch Q3 and the output capacitor region 203, and the input capacitor Cin and the upper switch can be respectively arranged on the first surface 101 and the second surface 102 or arranged on the same surface.

As shown in FIG. 2B, the switch region 202 of the second surface 102 is provided with a middle switch Q2, a middle switch Q4, a lower switch SR1 and a lower switch SR2. In some embodiments, the two middle switches and the two lower switches are sequentially arranged along the first port of the channel 45a according to the sequence of the middle switch, the lower switch, the lower switch and the middle switch; in some embodiments, the two lower switches SR1 and the lower switch SR2 are arranged adjacent to the first port of the channel 45a, the middle switch Q2 is arranged adjacent to the lower switch SR1, and the middle switch Q4 is arranged adjacent to the lower switch SR2, that is, the two middle switches are respectively arranged adjacent to the lower switches in the same bridge arm; at least one input capacitor Cin is arranged adjacent to the upper switch Q1 and part of the output capacitor region 203, at least another input capacitor Cin is arranged adjacent to the upper switch Q3 and the output capacitor region 203, and the input capacitor Cin and the upper switch can be respectively arranged on the first surface 101 and the second surface 102 or arranged on the same surface.

As shown in FIG. 2A and FIG. 2B, the switch provided on the first surface 102 corresponds to the switch provided on the first surface 101 in a one-to-one manner. The following switch SR1 is an example. The projection of the lower switch SR1 provided on the first surface 101 coincides with or completely coincides with the projection of the lower switch SR1 provided on the second surface 102 on the first surface, such that the source or drain of the two lower switches SR1 provided on the first surface 101 and the second surface 102 realize the parallel electrical connection of the two lower switch pins by means of the through bores or other via holes on the pin pad; the shortest distance of electrical connection between devices is realized and the power loss on the wires between the devices is reduced; two lower switches SR2 arranged on the first surface 101 and the second surface 102 in the same way, the two middle switches Q2 and the two middle switches Q4 also adopt the same setting principle, and details are not described again. On the second surface 102 shown in FIGS. 2B, at least one output capacitor Co is arranged on the output capacitor region 203, and the output capacitor region 203 is arranged adjacent to the lower switch SR1 or the lower switch SR2; the positive voltage terminal of the output capacitor Co located on the first surface 101 and the positive voltage terminal of the output capacitor Co located on the second surface 102 are short-circuited through the through bores or other via holes of the winding substrate on the pin bonding pad; and the negative voltage terminal of the output capacitor Co located on the first surface 101 and the negative voltage terminal of the output capacitor Co located on the second surface 102 are also short-circuited through the through bores or other via holes of the winding substrate on the pin bonding pad.

Furthermore, the projection of the upper switch of each switch bridge arm on the first surface 101 is adjacent to the projection on the first surface 101 of the middle switch of the same switch bridge arm, and the projection of the upper switch of each switch bridge arm on the first surface 101 is adjacent to the projection of the at least one output capacitor on the first surface 101. Meanwhile, the projection of at least one input capacitor Cin on the first surface 101 is adjacent to the projection of the upper switch Q1 of the first switch bridge arm 11a on the first surface 101 and the projection of at least one output capacitor Co on the first surface 101; and the projection of the at least one input capacitor Cin on the first surface 101 is adjacent to the projection of the upper switch Q3 of the second switch bridge arm 11b on the first surface 101 and the projection of the at least one output capacitor Co on the first surface 101.

According to the layout structure, the middle switch and the lower switch can be placed on the first surface 101 and the second surface 102 of the winding substrate 10 at the same time, the increase of the number of switches not only reduces the parasitic resistance of the switches, but also reduces the conduction loss generated on the switches. In the technical features disclosed by the embodiment of the invention, the magnetic component region, the switch region and the output capacitor area are sequentially arranged in the same direction, and furthermore, the magnetic component, the at least one lower switch and the at least one output capacitor are sequentially arranged in the same direction.

FIG. 2C is a schematic diagram of a winding method of a winding in a magnetic component 4. The first end of the low-voltage winding W21 is electrically connected to the lower node B1, and the drain of the lower switch SR1 is electrically connected in FIG. 2C. The low-voltage winding W21 sequentially passes through the first winding channel 44a and the second winding channel 44b from the first end to the second end, and is wound around the middle leg 42 in the same direction (such as a counter-clockwise direction). The second end of the low-voltage winding W21 is short-circuited with the second end of the low-voltage winding W22 and is electrically connected to the positive voltage terminal of the output capacitor; the first end of the low-voltage winding W22 is electrically connected to the lower node B2, and the drain of the lower switch SR2 is electrically connected in FIG. 2C; and the low-voltage winding W22 sequentially passes through the second winding channel 44b and the first winding channel 44a from the first end to the second end, and is wound around the middle leg 42 in the same direction (such as a clockwise direction). The low-voltage winding W21 and the second end of the low-voltage winding W22 are electrically connected to form a winding combination. The winding combination is wound around the middle leg in the same direction from the first end of the low-voltage winding W21 to the first end of the low-voltage winding W22 and is bridged between the lower node B1 and the lower node B2 of the two three-switch bridge arms. Due to the fact that the output capacitor is adjacent to the lower switch SR1 or the lower switch SR2, the low-voltage winding W21 or the low-voltage winding W22 is small in resistance value through a loop parasitic inductor and a parasitic AC resistor formed by the output capacitor and the lower switch connected with the output capacitor, and the AC conduction loss of the loop is reduced. Because the middle switch of each bridge arm is arranged adjacent to the lower switch, the upper switch is arranged adjacent to the middle switch, and the input capacitor Cin is arranged adjacent to the upper switch and the output capacitor, so that the loop formed by each bridge arm, the input capacitor Cin and the output capacitor Co is minimum, each switch of each bridge arm obtains good voltage clamping, and the switching loss of each switch is small.

In some embodiments, the first end of the high-voltage winding W1 is electrically connected with the source of the upper switch Q1, the second end of the high-voltage winding W1 is electrically connected with one end of the resonant capacitor CR, the high-voltage winding W1 is wound around the middle leg 42 in the same direction (such as a clockwise direction) from the first end to the second end, and the three circles shown in FIG. 2C are merely illustrative and do not represent that the high-voltage winding disclosed by the invention is limited by winding three circles; in detail, the high-voltage winding W1 is wound from the first end to the second end along the first port of the channel 45a from the source of the upper switch Q1, then passes through the second winding channel 44b, is wound along the second port of the channel 45b, passes through the first winding channel 44a, and is wound around the middle leg 42 clockwise around the middle leg 42; and the last circle of the high-voltage winding W1 passes through the first port of the channel 45a from the first winding channel 44a and is electrically connected with one end of the resonant capacitor Cr.

As shown in FIG. 2D, the switch region 202 on the first surface 101 or the second surface 102 is divided into a first bridge arm region 202a and a second bridge arm region 202b, at least a part of the switches in the first switch bridge arm is arranged in the first bridge arm region 202a, and at least a part of the switches in the second switch bridge arm is arranged in the second bridge arm region 202b; in some embodiments, on the first surface 101, the three switches of the first switch bridge arm are all arranged in the first bridge arm area 202a, and the three switches of the second switch bridge arm are all arranged in the second bridge arm area 202b; on the second surface 102, a middle switch Q2 and a lower switch SR1 of the first switch bridge arm are arranged in the first bridge arm region 202a; a middle switch Q4 and a lower switch SR2 of the second switch bridge arm are arranged in the second bridge arm region 202b.

As shown in FIG. 2D, in order to better reveal the winding mode of the winding, a switch, a magnetically permeable core, a capacitor and other devices arranged on the winding substrate 10 are ignored. In the winding substrate 10, the wiring of the high-voltage winding W1 from the upper node A1 to the first port of the channel 45a is defined as the first end W1a; in the resonant capacitor region 204, the wiring of the high-voltage winding W1 from the joint of one resonant capacitor Cr and high-voltage winding W1 to the first port of the channel 45a for the first time is defined as the second end W1b; and since the first end part W1a and the second end part W1b of the high-voltage winding W1 intersect horizontally, the overlapping region of the projection of the first end part W1a and the projection of the second end part W1b of the high-voltage winding W1 on the first surface 101 is defined as the projection overlapping region Wd1. Starting from the lower node B1, The low-voltage winding W21 from the lower node B1 to the first port of the channel 45a for the first time is defined as the first end part W22a of the low-voltage winding W21, and, the low-voltage winding W22 from the lower node B2 to the first port of the channel 45a for the first time is defined as the first end part W22a of the low-voltage winding W22; the first end part W21a of the low-voltage winding W21 and the first end part W22a of the low-voltage winding W22 are not horizontally crossed, so that the projection overlapping area caused by horizontal intersection is avoided.

In some embodiments, on the first surface 101, there is a straight line Line1 parallel to the winding substrate and passes through the projection overlapping region WD1, and the Line1 divides the first surface 101 into two opposite sides, which are respectively L1a and L1b; the upper node A1 and the lower node B1 of the first switch bridge arm 11a are located on the L1 aside, and the upper node A2 and the lower node B2 of the second switch bridge arm 11b are located on the L1b side. Further, as shown in FIG. 2E, the Line1 passes through the first port of the channel 45a, the second port of the channel 45b, and the middle leg 42. In some embodiments, the first bridge arm region 202a is located on the L1a side of the Line1, and the second bridge arm region 202b is located on the L1b side of the Line1, such that the first bridge arm region 202a and the second bridge arm region 202b are respectively located on two opposite sides of the Line1; the same technical feature is also suitable for the layout of related devices on the second surface 102, and details are not described herein again.

Furthermore, the Line1 approximately passes through the central axis of the middle leg 42, so that the first bridge arm region 202a and the second bridge arm region 202b are symmetrically distributed on two sides of the Line1; so that the connection distance between switches in each switch bridge arm is the shortest, and the loop formed by each switch bridge arm and the capacitor which is placed nearby and electrically connected with the switch bridge arm is minimum, so that the loop parasitic inductance is minimum, and the loss caused by turn-off of the bridge arm switches is minimum; and the working frequency of the power module is increased, and the advantage of small size of the power module is obtained.

In addition, the structure of the magnetically permeable core is not only limited to three magnetic legs, but also can only comprise one side leg 41 and one middle leg 42, as shown in FIG. 2F, a channel between the side leg 41 and the middle leg 42 is a winding channel 44; the winding mode of the high-voltage winding W1, the low-voltage winding W21 and the low-voltage winding W22 included in the magnetic component is similar to that shown in FIG. 2C, the high-voltage winding W1, the low-voltage winding W21 and the low-voltage winding W22 are wound around the middle leg 42, and the high-voltage winding W1, the low-voltage winding W21 and the low-voltage winding W22 penetrate through the winding channel 44; the first end part W1a of the high-voltage winding W1 horizontally intersects with the second end part W1b, and the projection of the first end part W1a on the first surface 101 overlaps with the projection of the second end part W1b on the first surface 101 to form a projection overlapping region Wd1; the first end part W21a of the low-voltage winding W21 and the first end part W22a of the low-voltage winding W22 are not horizontally crossed, and the projection of the first end part W21a on the first surface 101 does not overlap with the projection of the first end part W22a on the first surface 101. The switch region 202 is arranged on one side of the magnetic component 4, the magnetic component region 201, the switch region 202 and the output capacitor area 203 are sequentially arranged in the same direction, and further, the magnetic component, the at least one lower switch and the at least one output capacitor are sequentially arranged in the same direction. The arrangement of the switch region 202, the output capacitor region 203 and the resonant capacitor region 204 and the arrangement of components can all refer to the technical features described in some embodiments shown in FIGS. 2A-2E, the advantages of the embodiments described above can also be obtained.

In some embodiments, a straight line Line2 is provided, the Line2 is parallel to the winding substrate 10 and penetrates through the projection overlapping region Wd1, so that the upper node A1 and the lower node B1 of the first switch bridge arm 11a are located on the L2a side, and the upper node A2 and the lower node B2 of the second switch bridge arm 11b are located on the L2b side. In other words, there is another straight line parallel to the winding substrate, passing through the magnetically permeable core and enabling the first bridge arm region 202a and the second bridge arm region 202b to be respectively located at two sides of the straight line; further, the straight line is perpendicular to the winding channel 44.

### Embodiment 2

The application discloses a power conversion circuit with a pre-charging function. The power conversion circuit comprises a power conversion circuit part applying the circuit topology of FIGS. 1A or FIGS. 1B, a pre-charging circuit and a connection switch. The power conversion circuit further includes a first voltage terminal and a second voltage terminal. In some embodiments, the first voltage terminal is the input terminal Vin (ie, the first voltage positive terminal is the input positive terminal Vin+), the second voltage terminal is the output terminal Vo (ie, the second voltage positive terminal is the output positive terminal Vo+), the power conversion circuit is applied to a step-down power conversion device, and when the power conversion device is in a start-up state, the voltage at the two ends of the output capacitor Co is zero; the second pulse width modulation signal PWM2 is at a high level, the first pulse width modulation signal PWM1 is at a low level, a middle switch Q2 in the first switch bridge arm and an upper switch Q3 in the second switch bridge arm and a lower switch SR2 of the second switch bridge arm are conducted; the voltage at the two ends of the first switch bridge arm lower switch SR1 is clamped to be zero because of the zero voltage of the two ends of the output capacitor, the middle switch Q2 of the first switch bridge arm is switched on, and the voltage at the two ends of the middle switch Q2 is also zero, so that the two ends of the upper switch Q1 of the first switch bridge arm need to bear the input voltage Vin. Similarly, when the first pulse width modulation signal is at a high level and the second pulse width modulation signal is at a low level, the voltage at the two ends of the upper switch Q3 of the second switch bridge arm is also the input voltage Vin. Therefore, the upper switch of the two switch bridge arms needs to select a switching device with the rated voltage larger than 1.1 times of the maximum steady-state voltage of the first voltage terminal of the power conversion circuit, so that the switching device selected by the upper switch is high in withstand voltage, large in conduction resistance, large in conduction loss and low in efficiency.

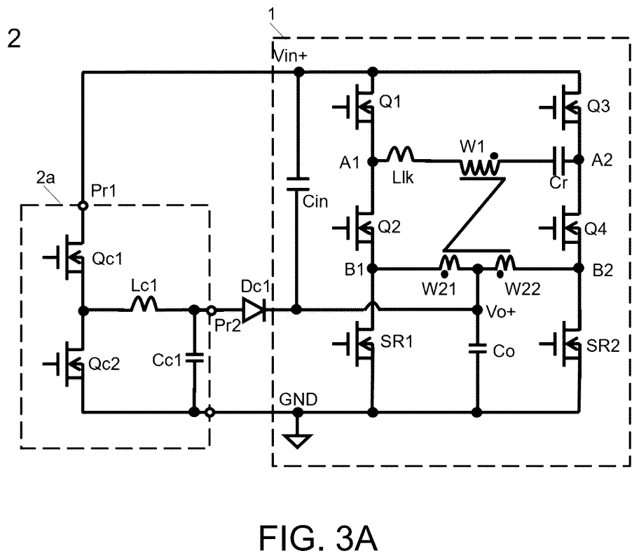

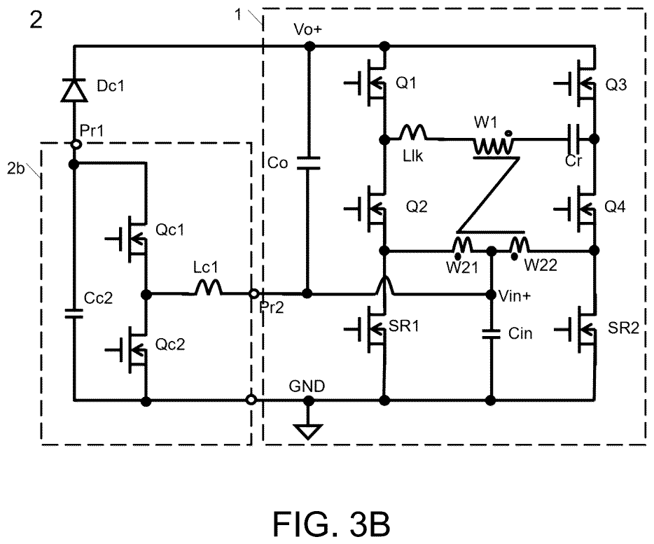

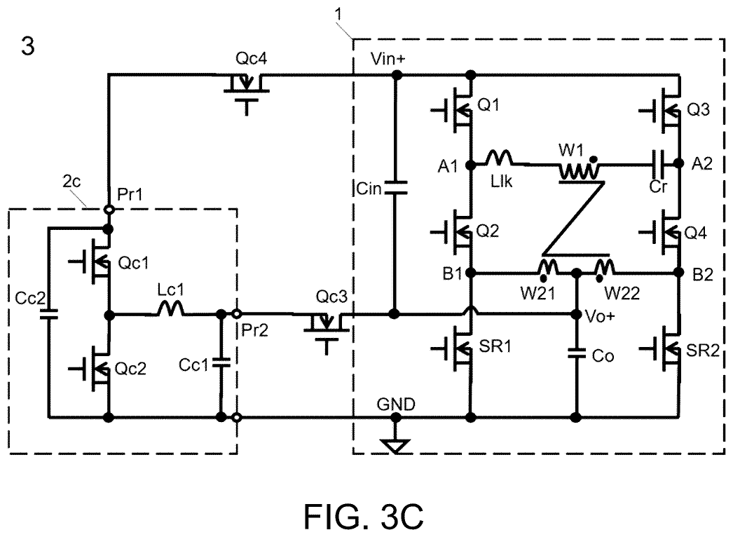

According to the pre-charging circuit 2a and the pre-charging diode Dc1 disclosed by the invention, the pre-charging circuit 2a is used for pre-charging the output capacitor Co in the power conversion circuit, so that when the power conversion circuit is started, the voltage at the two ends of the output capacitor Co is close to the voltage during steady-state working, and the damage of the inrush current flowing through the two bridge arm switches caused by the high voltage between the two ends of the equivalent resonant inductance can be avoided.; and meanwhile, the voltage withstanding requirement of the two upper switches is reduced. As shown in FIG. 3A, the pre-charging circuit 2a comprises three ports, namely a switch terminal PR1, an inductance terminal PR2 and a grounding terminal GND; the first voltage terminal of the power conversion circuit is an input terminal Vin, the second voltage terminal is an output terminal Vo, the grounding terminal GND of the pre-charging circuit 2a is electrically connected with one end of the power conversion circuit, the switch terminal Pr1 (at this time, the input terminal of the pre-charging circuit) is electrically connected to the input positive terminal Vin+, the inductance terminal Pr2 (at this time, the output terminal of the pre-charging circuit) is electrically connected to one end of a connection switch Dc1, and the other end of the pre-charging diode Dc1 is electrically connected to the output positive terminal Vo+. In some embodiments, the pre-charging diode Dc1 is a diode, but is not limited in sequence, and the connection switch may also be a controllable switch, such as a Si MOSFET, a SiC MOSFET, a GaN MOSFET or an IGBT MOSFET, etc., which can implement the functions of the connection switch disclosed in the application. Specifically, before the power conversion circuit is started, the first pulse width modulation signal PWM1 and the second pulse width modulation signal PWM2 are both low levels, at the moment, the pre-charging circuit 2a is started firstly, so that the voltage between the inductance terminal and the grounding terminal of the pre-charging circuit 2a is greater than the voltage at the two ends of the output capacitor Co, the pre-charging diode Dc1 is automatically switched on, the energy of the input terminal Vin is converted through the pre-charging circuit, and the voltage at the two ends of the output capacitor Co is pre-charged to a preset voltage, namely, the output steady-state voltage Vo_normal of the power conversion circuit; the pre-determined voltage is specifically greater than 70% of the output steady-state voltage Vo_normal of the power conversion circuit, and more specifically, the pre-determined voltage is equal to the output steady-state voltage Vo_normal of the power conversion circuit.

At the moment, the starting power conversion circuit is assumed to be at the 0 moment shown in FIG. 1C, the first pulse width modulation signal PWM1 is at a low level, the second pulse width modulation signal PWM2 is a high level, the upper switch Q3, the middle switch Q2 and the lower switch SR2 are in a “ON” state, and the upper switch Q1, the middle switch Q4 and the lower switch SR1 are in a “OFF” state; the voltages at the two ends of the lower switch SR1 are clamped to two times of output voltage (i.e., 2Vo_normal), because the middle switch Q2 of the first switch bridge arm is turned on, the cut-off voltages at the two ends of the upper switch Q1 are (Vin−2Vo_normal); similarly, when the first pulse width modulation signal PWM1 is at a high level and the second pulse width modulation signal PWM2 is at a low level, the cut-off voltage of the upper switch Q3 in the second switch bridge arm is also (Vin−2Vo_normal); and therefore, the cut-off voltage borne by the two ends of the two upper switches is (Vin−2Vo_normal); because Vo_normal=Vin/(n+2), n is the turn ratio of the high-voltage winding to the low-voltage winding, namely W1:W21:W22=N:1:1; taking N=2 and Vo=Vin/4 as an example, namely, the withstand voltage of the two upper switches is reduced to Vin/2 from Vin; and the two upper switches can select switching devices with rated voltage values smaller than 1.1*Vin_max (namely 1.1 times of the maximum steady-state voltage borne by the two ends of the first voltage terminal), even smaller than 0.9*Vin_max or 0.7*Vin_max.

In the application disclosed by the embodiment, the same technical effect can be achieved as long as the output terminal voltage of the power conversion device is pre-charged to the preset voltage through the pulse width modulation signal, the power conversion device starts to work (namely, the related switches in the two switch bridge arms in the power conversion device), and meanwhile, the pre-charging circuit stops working (i.e., turning off all the switches in the pre-charging circuit); the pre-determined voltage is specifically greater than 70% of the output steady-state voltage Vo_normal of the power conversion circuit, and more specifically, the pre-determined voltage is equal to the output steady-state voltage Vo_normal of the power conversion circuit. In detail, the pre-charging circuit 2a comprises two switches (i.e., a switch Qc1 and a switch Qc2), and a pre-charging inductor Lc1 and a pre-charging capacitor Cc1; the pre-charging circuit 2a is as shown in FIG. 3A and is electrically connected to a synchronous rectification BUCK converter; and after the switch Qc1 and the switch Qc2 are electrically connected in series, the pre-charging circuit 2a is bridged between the switch terminal Pr1 and the grounding terminal GND; one end of the pre-charging inductor is electrically connected with the electric connection points of the two switches, and the other end of the pre-charging inductor is electrically connected with the inductance end Pr2; and the pre-charging capacitor is connected between the inductance end Pr2 and the grounding terminal GND in a bridging mode. According to the embodiment, the synchronous rectification A Buck converter is adopted as a pre-charging circuit, no matter whether the load during starting of the pre-charging circuit 2a is light load or heavy load, the synchronous rectification Buck converter works in a current continuous mode (CCM), the gain of the power-level transfer function of the synchronous rectification Buck converter can be close under different loads, the synchronous rectification Buck converter can obtain high ride-through frequency and better dynamic response characteristic. The power stage transfer function is a transfer function from the duty cycle of the control signal of the synchronous rectification Buck converter to the output voltage.

When the circuit topology shown in FIG. 1B is used as a reverse converter, that is, the second voltage terminal of the power conversion circuit is the input terminal Vin (i.e., the second voltage positive terminal is the input positive terminal Vin+), and the first voltage terminal is the output terminal Vo (i.e., the first voltage positive terminal is the output positive terminal Vo+). A Boost converter is applied in the power conversion circuit, as shown in FIG. 3B, the pre-charging circuit disclosed by the present invention is also suitable for being electrically connected to the output positive terminal Vot by means of the pre-charging diode Dc1, the inductance terminal Pr2 (at this time, the input terminal of the pre-charging circuit) is directly electrically connected to the input positive terminal Vin+ of the power conversion circuit, and the grounding terminal GND of the pre-charging circuit is short-circuited with the grounding terminal GND of the power conversion circuit. Correspondingly, the pre-charging circuit 2b is electrically connected to a Boost converter as shown in FIGS. 3B, and after the two switches Qc1 and the switch Qc2 are electrically connected in series, the pre-charging circuit 2b is bridged between the switch terminal Pr1 and the grounding terminal GND; one end of the pre-charging inductor is electrically connected with the electrical connection points of the two switches, and the other end of the pre-charging inductor is electrically connected with the inductance terminal Pr2; and the pre-charging capacitor Cc2 is bridged between the switch terminal Pr1 and the grounding terminal GND; Specifically, before the power conversion circuit is started, both the first pulse width modulation signal PWM1 and the second pulse width modulation signal PWM2 are at a low level, and when the voltage at the two ends of the pre-charging capacitor Cc2 is greater than the voltage between the output positive terminal Vo+ and the ground terminal GND by controlling the on-off of the switches Qc1 and Qc2, the pre-charging diode Del is automatically turned on, so as to charge the voltage across the output capacitor Co in the power conversion device to a pre-determined voltage, the pre-determined voltage being greater than (0.7·Vo_normal−Vin), and more specifically, the pre-determined voltage is equal to (Vo_normal−Vin), and Vo_normal is the steady-state output voltage of the power conversion device; so that the damage of inrush current flowing through the two bridge arm switches caused by the high voltage between the two ends of the equivalent resonant inductance can be avoided.

In addition, when the power conversion device uses a plurality of power conversion circuits as shown in FIG. 3A or FIG. 3B to be connected in parallel, the output terminals (i.e., an inductor end PR2 or a switch terminal PR1) of a pre-charging circuit 2a or a pre-charging circuit 2b in the plurality of power conversion circuits are also connected in parallel; and if no connection switch exists, the outputs of the pre-charging circuit are connected in parallel, so that the problem of current backflow is easy to occur, and particularly under the working conditions of start-charging and quit-charging of the pre-charging circuit; when the output voltage of the pre-charging circuit is higher than the output terminal voltage of the power conversion device, the connection switch Dc1 is turned on, and when the output voltage of the pre-charging circuit is lower than the output terminal voltage of the power conversion device, the connection switch is turned off, so that the problem of current backflow when the plurality of power conversion circuits are connected in parallel is effectively solved.

However, when the connection switch adopts a diode, the defects of high conduction voltage drop and large conduction loss exist, the diode cannot meet the application of the power conversion device to the bidirectional converter at the same time, and in the application shown in FIG. 3C, a controllable switch (such as a Si MOSFET) is adopted as a connection switch to solve the problems. A first voltage terminal of the power conversion device is used as an input terminal Vin, a second voltage terminal is an output terminal Vo, a switch Qc3 is bridged between an inductance terminal Pr2 of the pre-charging circuit 2c (at the moment is an output terminal of the pre-charging circuit) and an output positive terminal Vot of the power conversion circuit, the switch Qc4 is bridged between the switching terminal Pr1 of the pre-charging circuit 2c (here, Pr1 is the input terminal of the pre-charging circuit) and an input positive terminal Vin+ of the power conversion circuit; the pre-charging capacitor Cc1 is bridged between the inductance terminal Pr2 and the grounding terminal GND, and the pre-charging capacitor Cc2 is bridged between the switch terminal Pr1 and the grounding terminal GND. Before the power conversion circuit is started, both the first pulse width modulation signal PWM1 and the second pulse width modulation signal PWM2 are at a low level. Firstly, the connection switch QC4 is in a normally-on state. When the voltage at the two ends of the pre-charging capacitor Cc1 is greater than the voltage between the output positive terminal Vo+ and the grounding terminal GND by controlling the on and off of the switches Qc1 and Qc2, the body diode of the connection switch Qc3 is turned on, and after the conduction current of the body diode is detected, the connection switch Qc3 is turned on, so that the voltage at the two ends of the connection switch Qc3 is reduced to the conduction voltage drop of the MOS tube from the body diode voltage drop; when the voltage of the output capacitor Co of the power conversion circuit rises, the current flowing through the connection switch Qc3 drops to a specific current value and below a specific current value, the connection switch Qc3 enters the amplification area, so that the voltage at the two ends of the connection switch is stabilized at a specific voltage value; and when the current flowing through the connection switch Qc3 continues to descend, the connection switch Qc3 is in an off state, meanwhile, the pre-charging process is finished, and the connection switch QC4 can be turned off at the moment.

When the power conversion device is applied to the second voltage terminal as the input terminal Vin, and the first voltage terminal is the output terminal Vo, before the power conversion circuit is started, the first pulse width modulation signal PWM1 and the second pulse width modulation signal PWM2 are both at low levels, so that the voltage at the two ends of the pre-charging capacitor Cc2 can be charged by controlling the switch Qc3 in on state and controlling the on and off of the switches Qc1 and Qc2, when the voltage at the two ends of the pre-charging capacitor Cc2 is greater than the voltage between the first positive terminal and the grounding terminal GND, and after the conduction current of the body diode is detected, the connection switch Qc4 is switched on, so that the voltage at the two ends of the connection switch Qc4 is reduced to the conduction voltage drop of the MOS tube from the body diode voltage drop; when the current flowing through the connecting switch QC4 drops to a specific current value and below a specific current value, the connecting switch QC4 enters the amplification area, so that the voltage at the two ends of the connecting switch is stabilized at a specific voltage value; and when the current flowing through the connecting switch QC4 continues to descend, the connecting switch QC4 is in a cut-off state, meanwhile, the pre-charging process is finished, and at the moment, the connecting switch Qc3 can be closed.

According to the pre-charging circuit disclosed by the invention, the output capacitor of the power conversion circuit can be pre-charged, so that the damage of the inrush current flowing through the upper switch and the middle switch is avoided at the starting moment. Meanwhile, the withstand voltage of the two upper switches is reduced, and a switch with a low rated voltage level can be selected; and the pre-charging circuit disclosed by the invention is simple and convenient to apply and easy to control, and meanwhile, current backflow when the plurality of power conversion circuits are connected in parallel can be avoided.

What is claimed is:

1. A power conversion device, comprising:
a magnetic component,
wherein the magnetic component comprises a magnetically permeable core and three windings, the magnetically permeable core comprises two core plates and at least two magnetic legs, the at least two magnetic legs are arranged between the two core plates, and a channel between every two adjacent magnetic legs is a winding channel;
wherein the magnetically permeable core further comprises a first port of the channel and a second port of the channel which are opposite to each other, the first port of the channel and the second port of the channel are two side faces of two core plates, and the winding channel penetrates through the first port of the channel and the second port of the channel;
wherein the three windings penetrate through the winding channel respectively, each winding in the three windings comprises a first end and a second end, and the first end and the second end of each winding in the three windings are arranged on the same side of the magnetically permeable core;
wherein the three windings are respectively a first winding, a second winding and a third winding, and the second end of the first winding and the second end of the second winding have different polarities and are electrically connected;
wherein the third winding comprises a first end part and a second end part, the first end part and the second end part are horizontally crossed, and a projection overlapping area is formed.

2. The power conversion device of claim 1, further comprising:
a winding substrate, wherein the three windings are arranged in the winding substrate, the winding substrate comprises at least two magnetically-permeable-core holes, and the magnetically-permeable-core holes are configured to allow the magnetic legs to pass through.

3. The power conversion device of claim 1, wherein the first winding and the second winding respectively comprise a first end part, and the first end part of the first winding and the first end part of the second winding are not horizontally crossed to form a projection overlapping area.

4. The power conversion device of claim 1, wherein the number of the at least two magnetic legs is three, the three magnetic legs are respectively a first side leg, a middle leg and a second side leg, the first side leg, the middle leg and the second side leg are arranged in the same direction, and a channel between every two adjacent magnetic legs is a winding channel;
wherein each winding sequentially passes through the two winding channels and is wound around the middle leg for at least one circle.

5. The power conversion device of claim 1, wherein a first end and a second end of each of the three windings are disposed on a first port of the channel of the magnetically permeable core.

6. The power conversion device of claim 2, further comprising:
a first switch bridge arm and a second switch bridge arm, wherein each switch bridge arm comprises an upper switch, a middle switch and a lower switch, the upper switch, the middle switch and the lower switch are sequentially and electrically connected in series, the connection points of the upper switch and the middle switch are upper nodes, and the connection points of the middle switch and the lower switch are lower nodes.

7. The power conversion device of claim 6, wherein the first end of the first winding and the first end of the second winding are electrically connected with the lower nodes of the first switch bridge arm and the second switch bridge arm respectively;
wherein the power conversion device further comprising:
a resonant capacitor, wherein after the first end part and the second end part of the third winding are horizontally crossed, the first end of the third winding is electrically connected with the upper node of the first switch bridge arm, the second end of the third winding is electrically connected with one end of the resonant capacitor, and the other end of the resonant capacitor is electrically connected with the upper node of the second switch bridge arm.

8. The power conversion device of claim 6, wherein the winding substrate comprises a first surface and a second surface opposite to each other, the first surface comprises a first bridge arm area and a second bridge arm area, and the second surface comprises a first bridge arm area and a second bridge arm area; at least one part of the switch of the first switch bridge arm is arranged in the first bridge arm area, and all or part of the switches of the second switch bridge arm are arranged in the second bridge arm area.

9. The power conversion device of claim 8, wherein the at least one part of the switch is a lower switch and a middle switch of the same switch bridge arm.

10. The power conversion device of claim 8, wherein a straight line parallel to the winding substrate and passing through the first port of the channel, the second port of the channel and the middle leg at the same time, and the first bridge arm region and the second bridge arm region are respectively located on two sides of the straight line.

11. The power conversion device of claim 8, wherein there is a straight line passing through the magnetically permeable core and parallel to the winding substrate, and the first bridge arm region and the second bridge arm region are respectively located on two sides of the straight line.

12. The power conversion device of claim 11, wherein the straight line is perpendicular to the winding channel.

13. The power conversion device of claim 6, wherein there is a straight line passing through the projection overlapping region and parallel to the winding substrate, and the node of the first bridge arm and the node of the second bridge arm are respectively located on two sides of the straight line.

14. A power conversion device, comprising:
an input terminal, wherein the input terminal comprises an input positive terminal and an input negative terminal;
an output terminal, wherein the output terminal comprises an output positive terminal and an output negative terminal;
two switch bridge arms, wherein the two switch bridge arms are connected in parallel between the input positive terminal and the input negative terminal;
a winding substrate, wherein the winding substrate comprises a first surface and a second surface which are opposite to each other, at least one surface comprises a magnetic component region, a switch region and an output capacitor area, and the magnetic component region, the switch region and the output capacitor area are sequentially arranged in one direction;
a magnetic component, wherein the magnetic component is arranged in the magnetic component region, a lower switch and a middle switch of the two switch bridge arms are arranged in the switch region; and
at least one output capacitor, wherein the at least one output capacitor is arranged in the output capacitor area.

15. The power conversion device of claim 14, wherein each switch bridge arm comprises an upper switch, a middle switch and a lower switch, the upper switch, the middle switch and the lower switch are sequentially and electrically connected in series, the connection points of the upper switch and the middle switch are upper nodes, and the connection points of the middle switch and the lower switch are lower nodes.

16. The power conversion device of claim 15, wherein the magnetic component comprises a magnetically permeable core, a first winding and a second winding, the first winding and the second winding respectively comprise a first end and a second end, the second end of the first winding is electrically connected with the second end of the second winding and is a non-dotted end, and the first ends of the first winding and the second winding are electrically connected with the lower node respectively.

17. The power conversion device of claim 16, wherein the magnetic component further comprises a third winding, the power conversion device further comprises a resonant capacitor, and the third winding and the resonant capacitor are electrically connected in series between the upper nodes of the two switch bridge arms in a bridging mode.

18. The power conversion device of claim 16, wherein the magnetic component further comprises a third winding, the power conversion device further comprises a resonant capacitor, the third winding comprises a first end part, a second end part and a first end and a second end, after the first end part and the second end part are horizontally crossed, the first end of the third winding is electrically connected with the upper node of the first switch bridge arm, the second end of the third winding is electrically connected with one end of the resonant capacitor, and the other end of the resonant capacitor is electrically connected with the upper node of the second switch bridge arm.

19. The power conversion device of claim 15, wherein the sources of the two lower switches are adjacently arranged and short-circuited, and the middle switch of each bridge arm is arranged adjacent to the lower switch of the same bridge arm.

20. The power conversion device of claim 19, wherein the middle switches of the two bridge arms are arranged on the two sides of the two lower switches respectively.

21. The power conversion device of claim 15, wherein the projection of the upper switch of each switch bridge arm on the first surface is adjacent to the projection of the middle switch of the same switch bridge arm on the first surface, and the projection of the upper switch of each switch bridge arm on the first surface is adjacent to the projection of the at least one output capacitor on the first surface.

22. The power conversion device of claim 15, further comprising:
at least two input capacitors, wherein the projections of each of the at least two input capacitors on the first surface are respectively adjacent to the projection of the upper switch of one of the two switch bridge arms on the first surface and the projection of the at least one output capacitor on the first surface.

23. A power conversion device, comprising:
a first voltage terminal, a second voltage terminal, two switch bridge arms, a magnetic component, and a pre-charging circuit;
wherein the first voltage terminal comprises a first voltage positive terminal and a first voltage negative terminal, the second voltage terminal comprises a second voltage positive terminal and a second voltage negative terminal, and the first voltage negative terminal is short-circuited with the second voltage negative terminal;
wherein the two switch bridge arms are connected in parallel between a first voltage positive terminal and a first voltage negative terminal, each switch bridge arm comprises an upper switch, a middle switch and a lower switch, the upper switch, the middle switch and the lower switch are sequentially and electrically connected in series, the connecting points of the upper switch and the middle switch are upper nodes, and the connecting points of the middle switch and the lower switch are lower nodes;
wherein the magnetic component comprises a first winding and a second winding, the first winding and the second winding respectively comprise a first end and a second end, the second end of the first winding is electrically connected with the second end of the second winding and is electrically connected with the positive terminal of the second voltage, and the first ends of the first winding and the second winding are electrically connected with the lower node respectively;
wherein before the middle switch is switched on, the pre-charging circuit pre-charges the voltage of the second voltage terminal to a pre-determined voltage, so that the rated voltage value of each upper switch is less than 1.1 times of the maximum steady-state voltage of the first voltage terminal.

24. The power conversion device of claim 23, wherein the rated voltage value of each of the upper switches is less than 0.9 times of the maximum steady-state voltage of the first voltage terminal.

25. The power conversion device of claim 24, wherein the rated voltage value of each of the upper switches is less than 0.7 times of the maximum steady-state voltage of the first voltage terminal.

26. The power conversion device of claim 23, wherein the pre-charging circuit is bridged between the first voltage terminal and the second voltage terminal.

27. The power conversion device of claim 23, wherein the first voltage terminal is an input terminal, and the second terminal voltage is an output terminal;
wherein the pre-determined voltage is greater than 70% of the steady-state voltage of the second voltage terminal.

28. The power conversion device of claim 23, wherein the pre-charging circuit comprises a switch terminal, an inductor end and a grounding terminal, the switch terminal is electrically connected with the first voltage positive terminal, the inductor end is electrically connected with the second voltage positive terminal, and the grounding terminal is electrically connected with the first voltage negative terminal and the second voltage negative terminal.

29. The power conversion device of claim 23, wherein the pre-charging circuit further comprises two switches, a pre-charging inductor and a pre-charging capacitor, the two switches are electrically connected in series and bridged between the switch terminal and the grounding terminal, the pre-charging inductor is bridged between the series connection point and the inductance terminal of the two switches, and the pre-charging capacitor is bridged between the inductance terminal and the grounding terminal.

30. The power conversion device of claim 29, further comprising:
a connection switch, wherein the connection switch is electrically connected between the inductance terminal of the pre-charging circuit and the second voltage positive terminal.

31. A power conversion circuit, comprising:
a first voltage terminal, a second voltage terminal, a pre-charging circuit, and at least one connection switch;
wherein the power conversion circuit realizes mutual conversion between a first voltage terminal voltage and a second voltage terminal voltage;
wherein the pre-charging circuit comprises a pre-charging input terminal, a pre-charging output terminal and a grounding terminal;
wherein one end of the at least one connecting switch is electrically connected with the pre-charging output terminal, and the other end of the at least one connecting switch is electrically connected with the first voltage terminal or the second voltage terminal of a power conversion device;
wherein the pre-charging circuit pre-charges a first voltage terminal or a second voltage terminal of the power conversion device to a pre-determined voltage, and then the power conversion circuit starts to work;
wherein the connection switch is turned on when the pre-charging circuit charges the power conversion device and has a current flowing through the connection switch.

32. The power conversion circuit of claim 31, wherein the pre-charging circuit pre-charges a first voltage terminal or a second voltage terminal of the power conversion circuit to a pre-determined voltage, and the pre-charging circuit stops working;
wherein the pre-determined voltage is greater than 70% of the output steady-state voltage of the power conversion circuit.

33. The power conversion circuit of claim 31, wherein the connection switch is turned off when the output current of the pre-charging circuit is zero or a negative current;
wherein the connection switch is a diode or a controllable switch.

34. The power conversion circuit of claim 31, wherein a first voltage terminal of the power conversion device is an input terminal, a second voltage terminal is an output terminal, the pre-charging input terminal is electrically connected to a first voltage terminal, and the connection switch is bridged between the pre-charging output terminal and the second voltage terminal.

35. The power conversion circuit of claim 34, wherein the pre-charging circuit further comprises two switches, a pre-charging inductor and at least one pre-charging capacitor; the two switches are electrically connected in series and are bridged between the pre-charging input terminal and the grounding terminal, the pre-charging inductor is bridged between the series connection point of the two switches and the pre-charging output terminal, and the pre-charging capacitor is bridged between the pre-charging output terminal and the grounding terminal.

36. The power conversion circuit of claim 31, wherein a first voltage terminal of the power conversion circuit is an output terminal, a second voltage terminal is an input terminal, the pre-charging input terminal is electrically connected with a second voltage terminal, and the connecting switch is connected between the pre-charging output terminal and the first voltage terminal in a bridging mode.

37. The power conversion circuit of claim 34, wherein the pre-charging circuit further comprises two switches, a pre-charging inductor and at least one pre-charging capacitor; the two switches are electrically connected in series and are bridged between the pre-charging output terminal and the grounding terminal, the pre-charging inductor is bridged between the series connection point of the two switches and the pre-charging input terminal, and the pre-charging capacitor is bridged between the pre-charging output terminal and the grounding terminal.

38. The power conversion circuit of claim 31, wherein the number of the connection switches is two, the pre-charging circuit further comprises two switches, a pre-charging inductor and two pre-charging capacitors, the two switches are electrically connected in series to form a series branch, and the electric connection point of the two switches is midpoint in the series branch; one end of the series branch is electrically connected with one end of one connection switch, and the other end of the series branch is electrically connected with the grounding terminal; and the other end of one connection switch is electrically connected with the positive terminal of the first voltage of the power conversion circuit; one end of the pre-charging inductor is electrically connected with the midpoint of the series branch, the other end of the pre-charging inductor is electrically connected with one end of the other connecting switch, and the other end of the other connecting switch is electrically connected with the positive terminal of the second voltage of the power conversion circuit; and each pre-charging capacitor is connected between one end of one connecting switch and the grounding terminal in a bridging mode.

39. The power conversion circuit of claim 31, wherein at least two power conversion circuits are electrically connected in parallel, first voltage terminals of the at least two power conversion circuits are connected in parallel, and second voltage terminals of the at least two power conversion circuits are connected in parallel.
